(19) United States
(12) Patent Application Publication
(10) Pub. No.: US 2024/0412109 A1
(43) Pub. Date: Dec. 12, 2024

(54) Multi-Agent Generative Adversarial Imitative Superlearning

(71) Applicant: PassiveLogic, Inc., Holladay, UT (US)

(72) Inventors: Troy Aaron Harvey, Holladay, UT (US); Jeremy David Fillingim, Salt Lake City, UT (US)

(73) Assignee: PassiveLogic, Inc., Holladay, UT (US)

(21) Appl. No.: 18/736,007

(22) Filed: Jun. 6, 2024

Related U.S. Application Data
(60) Provisional application No. 63/471,753, filed on Jun. 7, 2023.

(51) Int. Cl. G06N 20/00

(52) U.S. Cl. CPC G06N 20/00

(57) ABSTRACT

Various embodiments relate to a method, apparatus, and machine-readable storage medium including one or more of the following: using a resource intensive algorithm to answer a first question of a question type; generating at least one training example from the normal operation of the resource intensive algorithm; training a lightweight machine learning model based on the at least one training example to produce answers to questions of the question type; and using the lightweight machine learning model to produce an answer to a second question of the question type.

### INCORPORATION BY REFERENCE

This provisional application is related to U.S. provisional patent application No. 62/704,976, filed on Jun. 5, 2020, the entire disclosure of which is hereby incorporated by reference herein for all purposes.

### TECHNICAL FIELD

Various embodiments described herein relate to machine learning and, more specifically but not exclusively, machine learning techniques for speeding up or improving simulations.

### SUMMARY

According to various embodiments described herein, methods, devices, and non-transitory machine-readable media are described that include one or more of the following using a resource intensive algorithm to answer a first question of a question type; generating at least one training example from the normal operation of the resource intensive algorithm; training a lightweight machine learning model based on the at least one training example to produce answers to questions of the question type; and using the lightweight machine learning model to produce an answer to a second question of the question type.

Various embodiments are described wherein the resource intensive algorithm answers the first question by tuning at least one or more input of a simulator until an output of the simulator sufficiently meets a criteria of the question.

Various embodiments are described wherein the at least one training example includes: output of the simulation as input, and input to the simulation as output.

Various embodiments are described wherein the resource intensive algorithm is a multi-agent optimizer.

Various embodiments are described that additionally include: using the answer to the second question as a starting position of at least one agent of the multi-agent optimizer; and using the multi-agent optimizer to produce a refined answer to the second question.

Various embodiments are described wherein generating at least one training example comprises generating a training example from the location of an agent after each optimization iteration of the multi-agent optimizer.

Various embodiments are described that additionally include: using the answer to the second question as input to a simulator to produce a simulated result, and using the simulated result to verify acceptability of the answer to the second question.

Various embodiments are described that additionally include using the answer to the second question to perform at least one control action in a real world system.

Various embodiments are described wherein the resource intensive algorithm utilizes a digital twin of a real world system to answer the first question.

Various embodiments are described wherein using a resource intensive algorithm to answer a first question of a question type comprises computing a cost function from the digital twin.

Various embodiments are described that additionally include using the resource intensive algorithm to answer a third question of a different question type; generating at least one additional training example from the normal operation of the resource intensive algorithm; training an additional lightweight machine learning model based on the at least one additional training example to produce answers to questions of the different question type; and using the additional lightweight machine learning model to produce an answer to a fourth question of the different question type.

### BRIEF DESCRIPTION OF THE DRAWINGS

In order to better understand various example embodiments, reference is made to the accompanying drawings, wherein:

FIG. 1 illustrates an example environment for use of superlearners;

FIG. 2 illustrates an example extension of the environment to utilize superlearners;

FIG. 3 illustrates an example process of training superlearners;

FIG. 4 illustrates an example process of using and verifying superlearners;

FIG. 5 illustrates an example of multiple ways of using superlearners in the example environment; and

FIG. 6 illustrates an example hardware device for implementing superlearners.

FIG. 7 illustrates an example digital twin for use with superlearners.

### DETAILED DESCRIPTION

The description and drawings presented herein illustrate various principles. It will be appreciated that those skilled in the art will be able to devise various arrangements that, although not explicitly described or shown herein, embody these principles and are included within the scope of this disclosure. As used herein, the term, “or,” as used herein, refers to a non-exclusive or (i.e., and/or), unless otherwise indicated (e.g., “or else” or “or in the alternative”). Additionally, the various embodiments described herein are not necessarily mutually exclusive and may be combined to produce additional embodiments that incorporate the principles described herein.

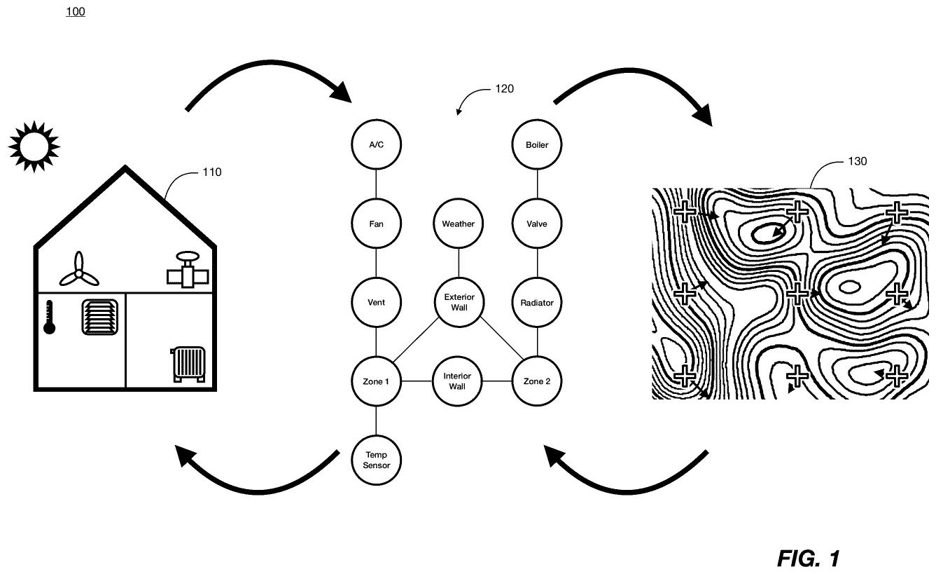

FIG. 1 illustrates an example environment 100 utilizing a simulator to drive control of a real world system. For example, the environment may include a building using with a heating, ventilation, and air conditioning (HVAC) system to be controlled using a digital twin based simulator. Various alternative environments for use of the methods and systems disclosed herein will be apparent such as, for example, a lighting system, an automated irrigation or other agricultural system, a power distribution system, a manufacturing or other industrial system, or virtually any other system that may be controlled. Further, the techniques disclosed herein may be applied outside the context of systems control, to any context where a question may be asked of a simulator or where the inputs of a simulator may be tuned to achieve a desired result.

As used herein, the term “question” will be understood to not be limited only to explicit queries that may be made of the digital twin or simulator in human language. Instead, “question” will refer to any discrete step of problem solving that the digital twin, simulator, or superlearners may be tasked with. For example, a question may include finding a control path, a creation of a state estimation in the future or past, optimizing comfort of occupants of a building (e.g., where not all occupants have the same comfort preferences, finding a “best” state to make everyone as comfortable as possible). While such questions may, for ease of understanding, be expressed herein in human language form, it will be understood that in implementation these questions may be expressed as contextual function or API calls or any other method in which a computer may define a discrete step of a problem to be solved or process to be performed.

As shown, the environment 100 includes a real world system 110. In this simplified example, the real world system 110 may include a building with two rooms, a temperature sensor, an air conditioning system including a fan and a vent, and a hydronic heating system including a boiler, a valve, and a radiator. The heating and cooling systems may be controllable by one or more controller devices such as a building management system. The controller may also receive feedback from the system, such as readings from the temperature sensor. It will be apparent that this example is simplified and that real systems may include numerous additional components to those described here.

The controller may have a digital model 120 of the real-world system 110 for use in basing its control decisions. For example the digital model 120 may be a digital twin of the real world system 110. As shown, the digital twin may be a neural network having heterogeneous, physics-based activation functions. Each neuron may represent, through ontological labeling and appropriate activation function selection, specific aspects of the real-world system 110. For example, individual neurons may be included to represent climate zones of the building, interior and exterior walls, temperature sensors, exterior weather, and HVAC equipment. With appropriate activation functions (e.g., heat transfer functions and fluid pressure/flow rate functions), the propagation of heat through the system can be simulated. Various embodiments may simulate additional or alternate characteristics such as humidity, voltage, fluid, components used in manufacturing, etc., as would be appropriate to simulate based on the application at hand.

To use the digital twin 120 to control the real world system 110, the controller may, for example, decide to open the valve of the simulated hydronic system, simulate the effects on the heat of Zone 1 and Zone 2 using the digital twin 120, decide whether the effect is the effect sought by the controller (or otherwise desirable), and if so issue the command to open the valve of the real world system 110. In this way, the controller can test many possible control actions against the simulator 120 and select the optimal control actions to actually implement.

In some embodiments, simply providing textbook physics-based activation functions to the digital twin 120 may be sufficient to provide an accurate enough simulation of the real world system 110. In other embodiments, the digital twin 120 may continue to learn from the real world system 110. By observing the operation of the real-world system 110, the controller can identify where the results of control actions diverge from those predicted according to the simulator and adapt the activation functions to better model the actually-observed behavior. Various machine learning techniques, such as gradient descent, for tuning activation functions of a neural network based on feedback or other training examples will be apparent.

While a controller could randomly guess at control actions until the digital twin 120 simulation indicates that a control action is desirable, the controller can use the digital twin 120 in a more directed manner to come to the correct control action for a desired result. As shown, for a particular problem, the controller can compute a cost function on a plurality of variables and the difference between a particular desired result and the simulated result, and then use one or more agents to find the optimal set of variables for a minimized cost. This agent-based solver 130 is shown as a topographical map on two dimensions (representing two variables/possible control actions), but it will be apparent that virtually any number of dimensions can be used, representing very complex decisions with much more numerous points of controls.

According to this approach, one or more agents are seeded on the cost function (e.g., randomly or evenly spaced). As shown in the agent-based solver, each agent is represented as a cross (“+”) symbol. After seeding, an optimization method such as gradient descent or self-organizing migrating algorithm (SOMA) may be used to find a minimum point of the cost function. The coordinates of that minimum point may indicate which control actions should and shouldn't be taken to achieve that minimum cost (i.e., the result that is closer than surrounding points to the desired result). In some instances, the minimum point may be a global minimum of the entire cost function, indicating the predicted best possible outcome. In other instances, the minimum point may be only a local minimum, indicating a predicted better outcome than others in the area, but not the predicted best possible outcome. Various approaches for handling sub-optimal control (or other answers) due to local minima in the cost function will be apparent.

As the complexity of the systems being simulated increases, the length of time needed for performing simulations or for optimizing the agent-based solver may increase, in some cases dramatically. To speed up the process of answering questions posed of the simulator (e.g., how should the HVAC system be controlled to bring Zone 1 and Zone 2 to a comfortable temperature) and to better avoid local minima, various embodiments employ imitative superlearners. These superlearners learn from the operation of the digital twin 120 and agent-based solver 130 to answer these questions faster or to seed the agents of the solver 130 at initial points closer to the global minimum (leading to faster optimization and greater likelihood of finding that global minimum).

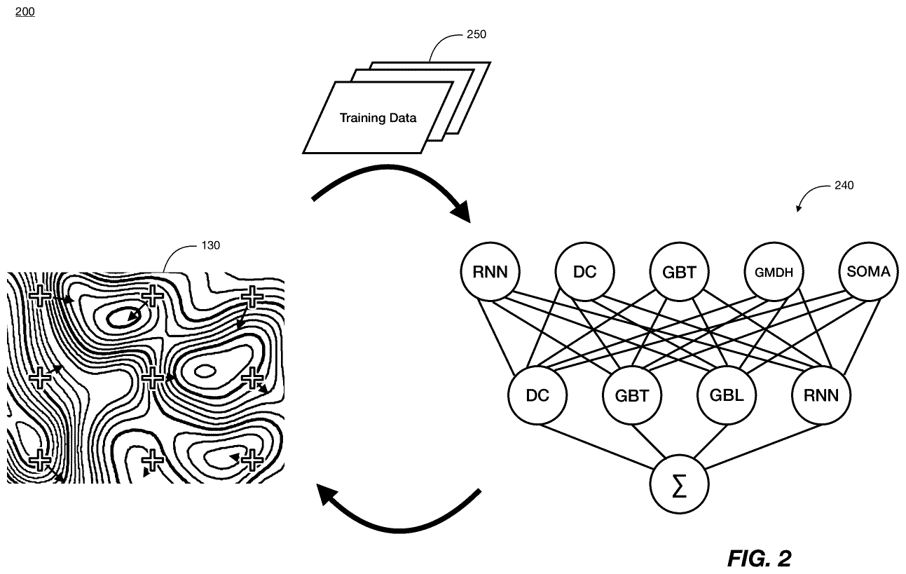

FIG. 2 illustrates an example extension 200 to the environment 100 for simulator based systems control that enables the use of imitative superlearners. As described above, the operation of the environment 100 entails a controller running many simulations against the digital twin 120. Each of these simulations therefore generates a training example: each agent, as it is optimized, generates examples of the form “for this question, this outcome (cost) is produced by these controls (remaining coordinates).” Having amassed a corpus of training examples through the normal operation of the controller, the controller can train one or more machine learning models on that specific question. As shown, the training data 250 is used to train an ensemble machine learning model including recurrent neural networks, SOMA, difference of convex functions algorithm, gradient boosting, group method of data handling, game-based learning, or other approaches and models. Other embodiments may additionally or alternatively use any of these approaches (or other known approaches/models) on its own without an ensemble, different ensembles with different arrangements of the models shown or other models known in the art, or virtually any other model or group of models that can be trained on training examples simulated by the controller.

As noted above, the superlearner 240 may be trained on a specific question, while the digital twin 120 simulator may be capable of use to answer any number of questions that may be posed. For example, the digital twin 120 simulator may be used to answer questions such as “what system controls will provide a comfortable temperature across all zones in the building?,” “what will the temperature in Zone 2 be 4 hours from now?,” “what is the humidity in the interior wall?,” “when should the boiler be turned on to have hot water in time for the next heating need?” Various additional questions will be apparent in the context of controlled HVAC systems, controlled systems of different types, and other problems outside of controlled systems to which an agent-based solver or simulation-based process is used.

In view of the multitude of questions that may be posed of the digital twin simulator/agent-based solver, the controller may train different superlearners for different questions. For example, the controller may train at least one superlearner for each question that may be or that has been posed to it, or may train superlearners only for a subset of such questions such as, for example, the most frequent questions, the questions most relevant to certain important tasks of the controller, the questions that take the longest time to answer without the use of superlearners, the questions that have the hardest time finding global minima without the use of superlearners, or a manually-defined (e.g., by a user or administrator) subset of questions.

In embodiments that train multiple superlearners, each superlearner may have the same characteristics (e.g., a single RNN having the same number of neurons or the same ensemble as pictured 240) or may have different characteristics from each other. For example, the model(s) selected and parameters thereof may be selected based on the question the superlearner is intended to answer. The models and characteristics may be manually selected, selected based on the question (e.g., using heuristics driven by the question and characteristics of the simulator), or even randomly selected and refined over the course of training and operation. In some embodiments, for a particular question, the controller may train multiple different superlearners of different types. The best performing superlearner may then be used in operation, or multiple of such superlearners may be used (e.g., by combining them in a new ensemble or by using them to drive different agents of the agent-based solver).

By training superlearners in this manner, the superlearners may remain suitable for answering questions over time, even in the face of changing circumstances of the system. For example, at any given time, the cost function for answering a particular question may differ from another time. This may due to a multitude of variations in the digital twin 120 or the real-world system 110 such as, for example, changes in outside temperature from day to day, changes in a desired temperature level, changes in the efficiency of a particular controlled device, changes to characteristics of the environment (e.g., opening a window in zone 1 leading to a change in thermal characteristics), or additions or changes in the digital twin itself (new or swapped equipment, new or moved sensors, etc). The superlearners may not be affected by such changes, or may be affected to a lesser degree than the digital twin and agent-based solver, such that the superlearners remain suitable accurate at answering their question in spite of some or all such changes.

In some embodiments, multiple superlearners may be trained to answer the same question. Various methods for utilizing multiple answers to a single question will be apparent. For example, the answers to multiple superlearners may be averaged or otherwise combined, thereby creating one or more a new ensembles that may be used as-is, or further trained to improve operation. As another example, the superlearners may be placed in competition with one another, and the answer from the best performing superlearner may be used. The “best performing” superlearner may be identified by, for example, simulating the outcome of each superlearner's answer and choosing the answer with the best outcome or keeping track of real-world observed outcomes when basing decisions off of each superlearner and deciding over time which superlearner leads to the best results. In some embodiments, different superlearners may perform “best” in different contexts or situations. For example, one superlearner may perform best in winter months, while another superlearner may perform best in summer months. In some such embodiments, the controller may track the “best performing” superlearners in each of a multitude of possible or relevant contexts.

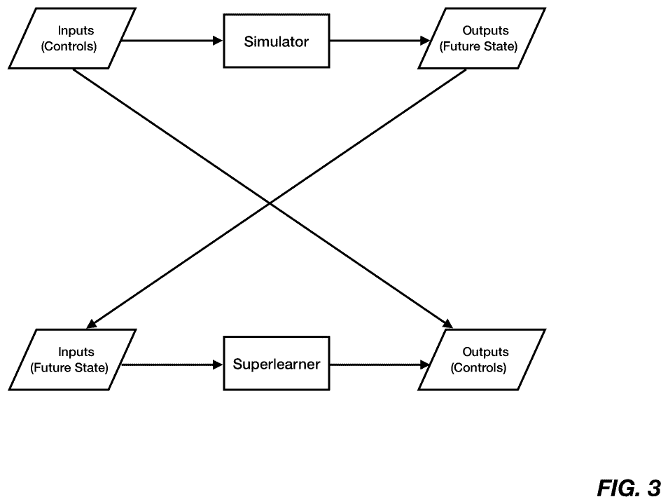

FIG. 3 illustrates an example of the training of a superlearner based on the simulator. In particular, FIG. 3 illustrates how a superleaner may be viewed as a “backward” implementation of a simulator. As shown, in the example of system controls, the simulator may be configured to accept a number of controls as input and then produce as output a simulated state expected to result from the input controls. After amassing a number of these paired inputs and outputs, the superlearner is trained to, instead, receive a future (e.g., desired) state as input and output a set of controls it believes will result in that future state.

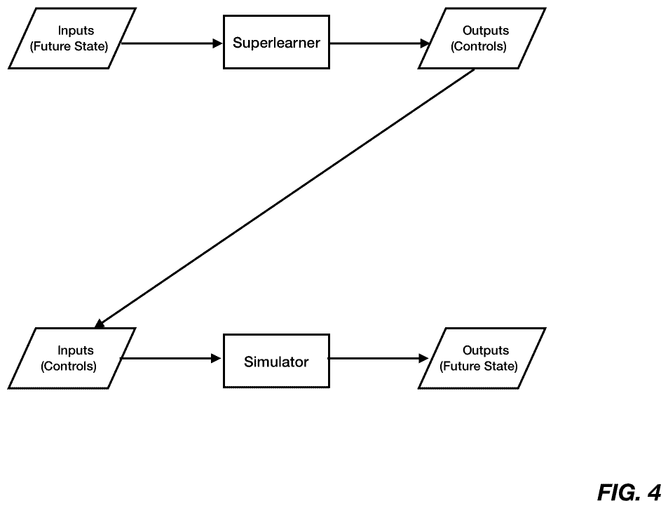

FIG. 4 illustrates an example of how a superlearner may be utilized after being trained. As shown and as previously described, the superlearner receives a future state as input and outputs a set of controls for achieving that future state. Those output controls may then be checked against the simulator—the controls are provided as input to the simulator to predict a future state. If the simulator predicts a future state the same as, or sufficiently close, to the future state provided to the superlearner, then the controller can trust that the controls provided by the superlearner are likely to be the correct controls to issue to the real-world system. In this way, the simulator is now used to “sanity check” the superlearner's answer to the question.

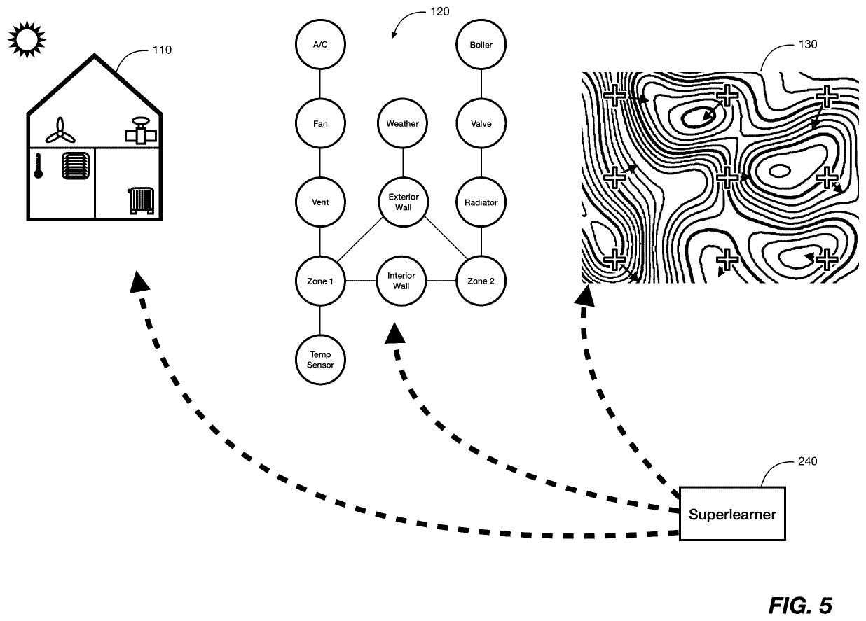

FIG. 5 further illustrates various options for using the output of a superlearner 240. As described above, for example, the output of the superlearner may be checked against the digital twin simulation 120 for a sanity check before the controller issues the controls to the real world system 110. Alternatively, in some cases (e.g., where the superlearner is trusted or where a very fast or even real-time decision is desired), the controller may directly issue the controls produced by the superlearner 240 to the real world system 110 (or may otherwise directly act on the answer produced by the superlearner without an additional check).

In some embodiments, where more of a check is needed or where multiple superlearners 240 are used for a particular question, the controller may use the output of the superlearner(s) 240 to drive the agent-based solver. For example, rather than randomly or evenly seeding the agents in the solver 130, one or more of the agents may be started at a point corresponding to the output of the superlearner(s) 240. In such an embodiment, once the superlearner(s) 240 are sufficiently trained, the agent-based solver 140 may switch entirely from randomly/evenly placed agent to only using agents placed by one or more superlearners 240. The superlearner(s) 240 may produce a result at or close to the global minimum of the cost function, and as such the subsequent optimization of the agents in the solver 130 may be much faster or more likely to find the global minimum than if the agents were randomly or arbitrarily placed.

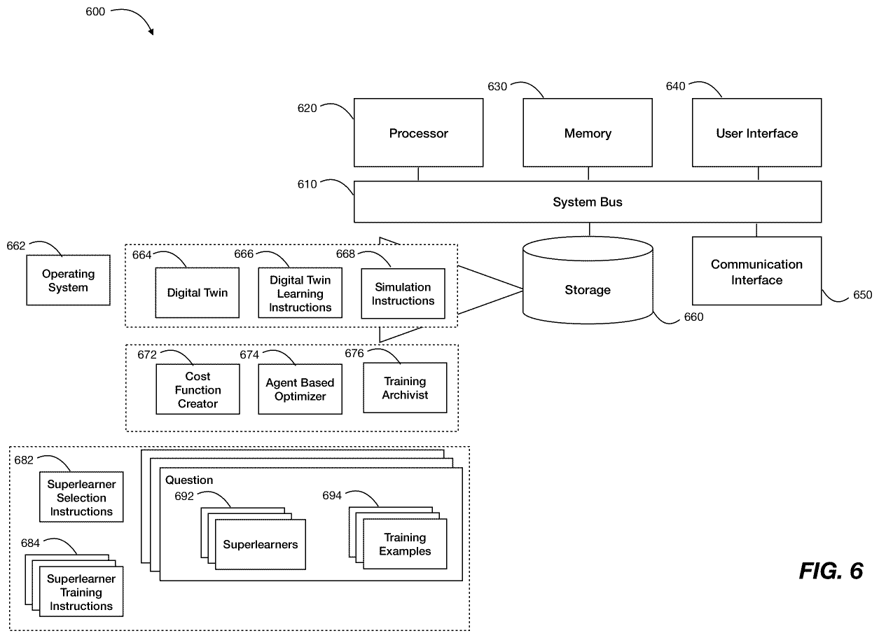

FIG. 6 illustrates an example hardware device 600 for implementing various embodiments. As shown, the device 600 includes a processor 620, memory 630, user interface 640, communication interface 650, and storage 660 interconnected via one or more system buses 610. It will be understood that FIG. 6 constitutes, in some respects, an abstraction and that the actual organization of the components of the device 600 may be more complex than illustrated.

The processor 620 may be any hardware device capable of executing instructions stored in memory 630 or storage 660 or otherwise processing data. As such, the processor may include a microprocessor, field programmable gate array (FPGA), application-specific integrated circuit (ASIC), or other similar devices.

The memory 630 may include various memories such as, for example L1, L2, or L3 cache or system memory. As such, the memory 630 may include static random access memory (SRAM), dynamic RAM (DRAM), flash memory, read only memory (ROM), or other similar memory devices. It will be apparent that, in embodiments where the processor includes one or more ASICs (or other processing devices) that implement one or more of the functions described herein in hardware, the software described as corresponding to such functionality in other embodiments may be omitted.

The user interface 640 may include one or more devices for enabling communication with a user such as an administrator. For example, the user interface 640 may include a display, a mouse, and a keyboard for receiving user commands. In some embodiments, the user interface 640 may include a command line interface or graphical user interface that may be presented to a remote terminal via the communication interface 650.

The communication interface 650 may include one or more devices for enabling communication with other hardware devices. For example, the communication interface 650 may include a network interface card (NIC) configured to communicate according to the Ethernet protocol. Additionally, the communication interface 650 may implement a TCP/IP stack for communication according to the TCP/IP protocols. In devices 600 that operate as a device controller, the communications interface 650 may additionally include one or more direct wired connections to such controlled devices. In applications where the device 600 is deployed in the context of an HVAC system, the communications interface may communicate according to an appropriate protocol such as BACnet. Various alternative or additional hardware or configurations for the communication interface 650 will be apparent.

The storage 660 may include one or more machine-readable storage media such as read-only memory (ROM), random-access memory (RAM), magnetic disk storage media, optical storage media, flash-memory devices, or similar storage media. In various embodiments, the storage 660 may store instructions for execution by the processor 620 or data upon with the processor 620 may operate. For example, the storage 660 may store a base operating system 662 for controlling various basic operations of the hardware 600.

The storage 660 may store a digital twin 664 that represents one or more environments or systems to be simulated. In various embodiments, the digital twin 664 may be formed as an omnidirectional, heterogenous, onotologically-labeled neural network as described above. As such, the digital twin may store a collection of descriptions of neurons and connections therebetween, including internal values (e.g., temperature and pressure) and activation functions. In various alternative embodiments, different types of digital twin constructions and formats may be used. Various digital twin characteristics necessary or useful for implementing the techniques described herein will be apparent such as, for example, the ability to propagate values according to physics-based transfer functions, the ability to define adjacency of the real world elements to be represented, and the ability to read values or otherwise introspect the digital twin 664 at desired locations.

The storage 660 may also include digital twin learning instructions 666 for continually adapting the digital twin 664 to better mimic the operation of the real-world system it models. For example, the digital twin learning instructions 666 may communicate with one or more devices in the real world system via the communication interface 650 to learn the state or operation of the real world system at various times or continuously. When the observed state or operation deviates from an expected state or operation from the digital twin 664, the digital twin learning instructions 666 may train the digital twin 664 based on the new information. For example, the digital twin learning instructions 666 may adjust one or more of the activation functions of the digital twin using an approach such as backpropagation.

Simulation instructions 668 may be included to operate on the digital twin 664. For example, the simulation instructions 668 may propagate values through the digital twin 664 as described above. As another example, the simulation instructions 668 may use the digital twin 664 to simulate the state of an environment or system over time after one or more possible control actions are taken. Such a simulation may help to identify a desired set of control actions to be taken with respect to a controlled system to achieve a desired state. Various additional uses or implementations for simulation instructions 668 will be apparent.

As shown, the digital twin 664, digital twin learning instructions 666, and simulation instructions 668 may form a group of software corresponding to the digital twin simulator 120.

The storage 660 may include a group of software 672, 674, 676 corresponding to the agent-based solver 130 and a group of software 682, 684, 692, 694 corresponding to the superlearners 240. It will be apparent that various additional software or components not described here may also form a part of these software groups.

Cost functions creator 672 may include instructions for generating a cost function from the digital twin 664. As will be understood, the specifics of the cost function will be determined based on the question being asked. Based on the question asked, the cost function creator may create a function representable as a multidimensional contour with dimensions corresponding to the variables making up the question's answer (e.g., one or more possible control actions) and the cost (i.e., the predicted difference between the desired output and the predicted output for the variables).

Agent based optimizer 674 may include instructions for performing an agent based optimization on the cost function, to find an answer to the question at hand. For example, as disclosed above, multiple agents may be utilized to find a minimum on the cost function using methods such as gradient descent or SOMA. The initial position of the agents may be determined according to various approaches. For example, the agents may be started at random or eveny-spaced points in the cost function, particularly at a point in the system's operation where superlearners have not yet been trained for the question at hand. As another example, the agents may be positioned at a point specified by one or more superlearners, when superlearners are available for the question at hand. It will be apparent that various alternative approaches to optimizing a cost function may be used by the optimizer 674, including approaches that are not based on multiple agents. Techniques for using trained superlearners to start such optimizations at better-than-arbitrary starting points or to otherwise inform the operation of such optimizations will be apparent.

The training archivist 676 may include instructions for generating training examples for the questions at hand. As explained, the training archivist 676 may monitor the operation of the agent based optimized 674 and generate training examples. For example, at each iteration of each agent, an example of a set of inputs and a predicted output is generated. The training archivist 676 may swap the inputs and outputs to create a “backward” training example: a training example of the form “this output can be created by these inputs.”

The superlearner selection instructions 682 may include instructions for establishing one or more superlearners 692 for a particular question. The superlearner selection instructions 682 may also decide for which questions superlearners 692 will be established. In some embodiments, the superlearner selection instructions 682 may simply establish a list of all preconfigured model types (and ensembles thereof) for each question, and let post-training performance determine which superlearners have an impact on system operation. In other embodiments, the superlearner selection instructions 682 may intelligently select or construct one or more models for the superlearners 692 that will perform well for the question at hand. For example, a heuristic-based approach may be used to indicate one set of models (or construction thereof) may perform well for questions of one form, while another set of models (or constructions thereof) may perform well for questions of another form.

Superlearner 684 training instructions may include one or more algorithms for using the training examples 694 generated by the training archivist 676 to train the superlearners 692. As will be appreciated, the superlearner training instructions 684 may implement different training algorithms appropriate to the different superlearner 692 types employed. In some embodiments, the superlearner training instructions 684 may be responsible for initially training the superlearners 692 and then indicating to the agent based optimizer 674 (or other component) when one or more superlearners 692 are ready for use. In some embodiments, after initial training, the training archivist 676 may continue to make additional training examples 694 as the agent-based optimizer 674 continues to answer questions. In such embodiments, the superlearner training instructions 684 may continue to periodically or continually refined the superlearners 692 based on the newly-available training examples 694.

As shown, the storage 660 may include a set of superlearners 692 and a set of training examples 694 for each of a number of questions that may be asked of the digital twin 664. Once trained, the superlearners 692 may, in response to the system asking a particular question, provide one or more answers to the agent based optimizer 674 (e.g., for seeding one or more agents at better-than-arbitrary points), to the simulation instructions 668 (for a sanity check), or directly to the asking process (not shown) (e.g., a process that will send control instructions to the real world system via the communication interface 650.

It will be apparent that various information described as stored in the storage 360 may be additionally or alternatively stored in the memory 330. In this respect, the memory 330 may also be considered to constitute a “storage device” and the storage 360 may be considered a “memory.” Various other arrangements will be apparent. Further, the memory 330 and storage 360 may both be considered to be “non-transitory machine-readable media.” As used herein, the term “non-transitory” will be understood to exclude transitory signals but to include all forms of storage, including both volatile and non-volatile memories.

While the hardware device 300 is shown as including one of each described component, the various components may be duplicated in various embodiments. For example, the processor 320 may include multiple microprocessors that are configured to independently execute the methods described herein or are configured to perform steps or subroutines of the methods described herein such that the multiple processors cooperate to achieve the functionality described herein, such as in the case where the device 300 participates in a distributed processing architecture with other devices which may be similar to device 300. Further, where the device 300 is implemented in a cloud computing system, the various hardware components may belong to separate physical systems. For example, the processor 320 may include a first processor in a first server and a second processor in a second server.

It should be apparent from the foregoing description that various example embodiments of the invention may be implemented in hardware or firmware. Furthermore, various exemplary embodiments may be implemented as instructions stored on a machine-readable storage medium, which may be read and executed by at least one processor to perform the operations described in detail herein. A machine-readable storage medium may include any mechanism for storing information in a form readable by a machine, such as a personal or laptop computer, a mobile device, a tablet, a server, or other computing device. Thus, a machine-readable storage medium may include read-only memory (ROM), random-access memory (RAM), magnetic disk storage media, optical storage media, flash-memory devices, and similar storage media.

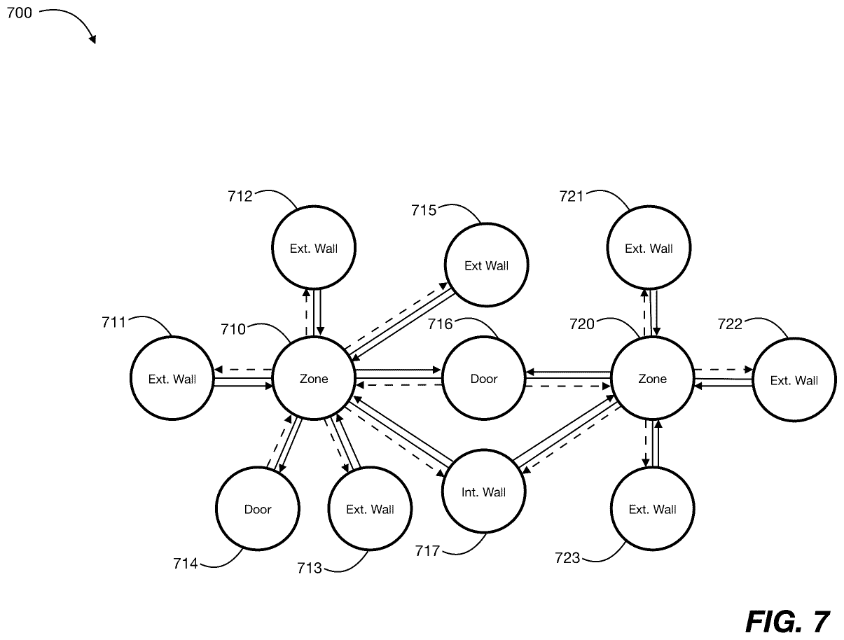

FIG. 7 illustrates an example digital twin 700 for construction by or use in various embodiments. The digital twin 700 may correspond, for example, to digital twin 664 or digital twin model 210. As shown, the digital twin 700 includes a number of nodes 710, 711, 712, 713, 714, 715, 716, 720, 721, 722, 723 connected to each other via edges. As such, the digital twin 700 may be arranged as a graph, such as a neural network. In various alternative embodiments, other arrangements may be used. Further, while the digital twin 700 may reside in storage as a graph type data structure, it will be understood that various alternative data structures may be used for the storage of a digital twin 700 as described herein. The nodes 710-723 may correspond to various aspects of a building structure such as zones, walls, and doors. The edges between the nodes 710-723 may, then, represent relationships between the aspects represented by the nodes 710-723 such as, for example, adjacency for the purposes of heat transfer.

As shown, the digital twin 700 includes two nodes 710, 720 representing zones. A first zone node 710 is connected to four exterior wall nodes 711, 712, 713, 715; two door nodes 714, 716; and an interior wall node 717. A second zone node 720 is connected to three exterior wall nodes 721, 722, 723; a door node 716; and an interior wall node 717. The interior wall node 717 and door node 716 are connected to both zone nodes 710, 720, indicating that the corresponding structures divide the two zones. This digital twin 700 may thus correspond to a two-room structure.

It will be apparent that the example digital twin 700 may be, in some respects, a simplification. For example, the digital twin 700 may include additional nodes representing other aspects such as additional zones, windows, ceilings, foundations, roofs, or external forces such as the weather or a forecast thereof. It will also be apparent that in various embodiments the digital twin 700 may encompass alternative or additional systems such as controllable systems of equipment (e.g., HVAC systems).

According to various embodiments, the digital twin 700 is a heterogenous neural network. Typical neural networks are formed of multiple layers of neurons interconnected to each other, each starting with the same activation function. Through training, each neuron's activation function is weighted with learned coefficients such that, in concert, the neurons cooperate to perform a function. The example digital twin 700, on the other hand, may include a set of activation functions (shown as solid arrows) that are, even before any training or learning, differentiated from each other, i.e., heterogenous. In various embodiments, the activation functions may be assigned to the nodes 710-723 based on domain knowledge related to the system being modeled. For example, the activation functions may include appropriate heat transfer functions for simulating the propagation of heat through a physical environment (such as function describing the radiation of heat from or through a wall of particular material and dimensions to a zone of particular dimensions). As another example, activation functions may include functions for modeling the operation of an HVAC system at a mathematical level (e.g., modeling the flow of fluid through a hydronic heating system and the fluid's gathering and subsequent dissipation of heat energy). Such functions may be referred to as “behaviors” assigned to the nodes 710-723. In some embodiments, each of the activation functions may in fact include multiple separate functions; such an implementation may be useful when more than one aspect of a system may be modeled from node-to-node. For example, each of the activation functions may include a first activation function for modeling heat propagation and a second activation function for modeling humidity propagation. In some embodiments, these diverse activation functions along a single edge may be defined in opposite directions. For example, a heat propagation function may be defined from node 710 to node 711, while a humidity propagation function may be defined from node 711 to node 710. In some embodiments, the diversity of activation functions may differ from edge to edge. For example, one activation function may include only a heat propagation function, another activation function may include only a humidity propagation function, and yet another activation function may include both a heat propagation function and a humidity propagation function.

According to various embodiments, the digital twin 700 is an omnidirectional neural network. Typical neural networks are unidirectional-they include an input layer of neurons that activate one or more hidden layers of neurons, which then activate an output layer of neurons. In use, typical neural networks use a feed-forward algorithm where information only flows from input to output, and not in any other direction. Even in deep neural networks, where other paths including cycles may be used (as in a recurrent neural network), the paths through the neural network are defined and limited. The example digital twin 700, on the other hand, may include activation functions along both directions of each edge: the previously discussed “forward” activation functions (shown as solid arrows) as well as a set of “backward” activation functions (shown as dashed arrows).

In some embodiments, at least some of the backward activation functions may be defined in the same way as described for the forward activation functions-based on domain knowledge. For example, while physics-based functions can be used to model heat transfer from a surface (e.g., a wall) to a fluid volume (e.g., an HVAC zone), similar physics-based functions may be used to model heat transfer from the fluid volume to the surface. In some embodiments, some or all of the backward activation functions are derived using automatic differentiation techniques. Specifically, according to some embodiments, reverse mode automatic differentiation is used to compute the partial derivative of a forward activation function in the reverse direction. This partial derivative may then be used to traverse the graph in the opposite direction of that forward activation function. Thus, for example, while the forward activation function from node 711 to node 710 may be defined based on domain knowledge and allow traversal (e.g., state propagation as part of a simulation) from node 711 to node 710 in linear space, the reverse activation function may be defined as a partial derivative computed from that forward activation function and may allow traversal from node 710 to 711 in the derivative space. In this manner, traversal from any one node to any other node is enabled—for example, the graph may be traversed (e.g. state may be propagated) from node 712 to node 713, first through a forward activation function, through node 710, then through a backward activation function. By forming the digital twin as an omnidirectional neural network, its utility is greatly expanded; rather than being tuned for one particular task, it can be traversed in any direction to simulate different system behaviors of interest and may be “asked” many different questions.

According to various embodiments, the digital twin is an ontologically labeled neural network. In typical neural networks, individual neurons do not represent anything in particular; they simply form the mathematical sequence of functions that will be used (after training) to answer a particular question. Further, while in deep neural networks, neurons are grouped together to provide higher functionality (e.g. recurrent neural networks and convolutional neural networks), these groupings do not represent anything other than the specific functions they perform; i.e., they remain simply a sequence of operations to be performed.

The example digital twin 700, on the other hand, may ascribe meaning to each of the nodes 710-723 and edges therebetween by way of an ontology. For example, the ontology may define each of the concepts relevant to a particular system being modeled by the digital twin 700 such that each node or connection can be labeled according to its meaning, purpose, or role in the system. In some embodiments, the ontology may be specific to the application (e.g., including specific entries for each of the various HVAC equipment, sensors, and building structures to be modeled), while in others, the ontology may be generalized in some respects. For example, rather than defining specific equipment, the ontology may define generalized “actors” (e.g., the ontology may define producer, consumer, transformer, and other actors for ascribing to nodes) that operate on “quanta” (e.g., the ontology may define fluid, thermal, mechanical, and other quanta for propagation through the model) passing through the system. Additional aspects of the ontology may allow for definition of behaviors and properties for the actors and quanta that serve to account for the relevant specifics of the object or entity being modeled. For example, through the assignment of behaviors and properties, the functional difference between one “transport” actor and another “transport” actor can be captured.

The above techniques, alone or in combination, may enable a fully-featured and robust digital twin 700, suitable for many purposes including system simulation and control path finding. The digital twin 700 may be computable and trainable like a neural network, queryable like a database, introspectable like a semantic graph, and callable like an API.

As described above, the digital twin 700 may be traversed in any direction by application of activation functions along each edge. Thus, just like a typical feedforward neural network, information can be propagated from input node(s) to output node(s). The difference is that the input and output nodes may be specifically selected on the digital twin 700 based on the question being asked, and may differ from question to question. In some embodiments, the computation may occur iteratively over a sequence of timesteps to simulate over a period of time. For example, the digital twin 700 and activation functions may be set at a particular timestep (e.g., 1 minute), such that each propagation of state simulates the changes that occur over that period of time. Thus, to simulate longer period of time or point in time further in the future (e.g., one minute), the same computation may be performed until a number of timesteps equaling the period of time have been simulated (e.g., 60 one second time steps to simulate a full minute). The relevant state over time may be captured after each iteration to produce a value curve (e.g., the predicted temperature curve at node 710 over the course of a minute) or a single value may be read after the iteration is complete (e.g., the predicted temperature at node 710 after a minute has passed). The digital twin 700 may also be inferenceable by, for example, attaching additional nodes at particular locations such that they obtain information during computation that can then be read as output (or as an intermediate value as described below).

While the forward activation functions may be initially set based on domain knowledge, in some embodiments training data along with a training algorithm may be used to further tune the forward activation functions or the backward activation functions to better model the real world systems represented (e.g., to account for unanticipated deviations from the plans such as gaps in venting or variance in equipment efficiency) or adapt to changes in the real world system over time (e.g., to account for equipment degradation, replacement of equipment, remodeling, opening a window, etc.).

Training may occur before active deployment of the digital twin 700 (e.g., in a lab setting based on a generic training data set) or as a learning process when the digital twin 700 has been deployed for the system it will model. To create training data for active-deployment learning, a controller device (not shown) may observe the data made available from the real-world system being modeled (e.g., as may be provided by a sensor system deployed in the environment 110) and log this information as a ground truth for use in training examples. To train the digital twin 700, that controller may use any of various optimization or supervised learning techniques, such as a gradient descent algorithm that tunes coefficients associated with the forward activation functions or the backward activation functions. The training may occur from time to time, on a scheduled basis, after gathering of a set of new training data of a particular size, in response to determining that one or more nodes or the entire system is not performing adequately (e.g., an error associated with one or more nodes 710-723 passed a threshold or passes that threshold for a particular duration of time), in response to manual request from a user, or based on any other trigger. In this way, the digital twin 700 may be adapted to better adapt its operation to the real world operation of the systems it models, both initially and over the lifetime of its deployment, by tacking itself to the observed operation of those systems.

The digital twin 700 may be introspectable. That is, the state, behaviors, and properties of the 710-723 may be read by another program or a user. This functionality is facilitated by association of each node 710-723 to an aspect of the system being modeled. Unlike typical neural networks where, due to the fact that neurons don't represent anything particularly the internal values are largely meaningless (or perhaps exceedingly difficult or impossible to ascribe human meaning), the internal values of the nodes 710-723 can easily be interpreted. If an internal “temperature” property is read from node 710, it can be interpreted as the anticipated temperature of the system aspect associated with that node 710.

Through attachment of a semantic ontology, as described above, the introspectability can be extended to make the digital twin 700 queryable. That is, ontology can be used as a query language usable to specify what information is desired to be read from the digital twin 700. For example, a query may be constructed to “read all temperatures from zones having a volume larger than 200 square feet and an occupancy of at least 1.” A process for querying the digital twin 700 may then be able to locate all nodes 710-723 representing zones that have properties matching the volume and occupancy criteria, and then read out the temperature properties of each. The digital twin 700 may then additionally be callable like an API through such processes. With the ability to query and inference, canned transactions can be generated and made available to other processes that aren't designed to be familiar with the inner workings of the digital twin 700. For example, an “average zone temperature” API function could be defined and made available for other elements of the controller or even external devices to make use of. In some embodiments, further transformation of the data could be baked into such canned functions. For example, in some embodiments, the digital twin 700 itself may not itself keep track of a “comfort” value, which may defined using various approaches such as the Fanger thermal comfort model. Instead, e.g., a “zone comfort” API function may be defined that extracts the relevant properties (such as temperature and humidity) from a specified zone node, computes the comfort according to the desired equation, and provides the response to the calling process or entity.

It will be appreciated that the digital twin 700 is merely an example of a possible embodiment and that many variations may be employed. In some embodiments, the number and arrangements of the nodes 710-723 and edges therebetween may be different, either based on the device implementation or based on the system being modeled. For example, a controller deployed in one building may have a digital twin 700 organized one way to reflect that building and its systems while a controller deployed in a different building may have a digital twin 700 organized in an entirely different way because the building and its systems are different from the first building and therefore dictate a different model. Further, various embodiments of the techniques described herein may use alternative types of digital twins. For example, in some embodiments, the digital twin 700 may not be organized as a neural network and may, instead, be arranged as another type of model for one or more components of the environment 110. In some such embodiments, the digital twin 700 may be a database or other data structure that simply stores descriptions of the system aspects, environmental features, or devices being modeled, such that other software has access to data representative of the real world objects and entities, or their respective arrangements, as the software performs its functions.

It should be appreciated by those skilled in the art that any block diagrams herein represent conceptual views of illustrative circuitry embodying the principles of the invention. Similarly, it will be appreciated that any flow charts, flow diagrams, state transition diagrams, pseudo code, and the like represent various processes which may be substantially represented in machine readable media and so executed by a computer or processor, whether or not such computer or processor is explicitly shown.

Although the various exemplary embodiments have been described in detail with particular reference to certain example aspects thereof, it should be understood that the invention is capable of other embodiments and its details are capable of modifications in various obvious respects. As is readily apparent to those skilled in the art, variations and modifications can be affected while remaining within the spirit and scope of the invention. Accordingly, the foregoing disclosure, description, and figures are for illustrative purposes only and do not in any way limit the scope of the claims.

1. A method for improving simulation-based question answering, the method comprising:
using a resource intensive algorithm to answer a first question of a question type;
generating at least one training example from the normal operation of the resource intensive algorithm;
training a lightweight machine learning model based on the at least one training example to produce answers to questions of the question type; and
using the lightweight machine learning model to produce an answer to a second question of the question type.

2. The method of claim 1, wherein the resource intensive algorithm answers the first question by tuning at least one or more input of a simulator until an output of the simulator sufficiently meets a criteria of the question.

3. The method of claim 2, wherein the at least one training example includes:
output of the simulation as input, and
input to the simulation as output.

4. The method of claim 1, wherein the resource intensive algorithm is a multi-agent optimizer.

5. The method of claim 4, further comprising:
using the answer to the second question as a starting position of at least one agent of the multi-agent optimizer; and
using the multi-agent optimizer to produce a refined answer to the second question.

6. The method of claim 4, wherein generating at least one training example comprises generating a training example from the location of an agent after each optimization iteration of the multi-agent optimizer.

7. The method of claim 1, further comprising:
using the answer to the second question as input to a simulator to produce a simulated result, and
using the simulated result to verify acceptability of the answer to the second question.

8. The method of claim 1, further comprising:
using the answer to the second question to perform at least one control action in a real world system.

9. The method of claim 1, wherein the resource intensive algorithm utilizes a digital twin of a real world system to answer the first question.

10. The method of claim 9, wherein using a resource intensive algorithm to answer a first question of a question type comprises computing a cost function from the digital twin.

11. The method of claim 1, further comprising:
using the resource intensive algorithm to answer a third question of a different question type;
generating at least one additional training example from the normal operation of the resource intensive algorithm;
training an additional lightweight machine learning model based on the at least one additional training example to produce answers to questions of the different question type; and
using the additional lightweight machine learning model to produce an answer to a fourth question of the different question type.

12. A controller that utilizes a simulation in controlling a real world system, the controller comprising a memory and a processer, wherein the processor is in communication with the memory configured to:
use a resource intensive algorithm to answer a first question of a question type;
generate at least one training example from the normal operation of the resource intensive algorithm;
train a lightweight machine learning model based on the at least one training example to produce answers to questions of the question type; and
use the lightweight machine learning model to produce an answer to a second question of the question type.

13. The controller of claim 12, further comprising the processor configured to:
use the resource intensive algorithm to answer a third question of a different question type;
generate at least one additional training example from the normal operation of the resource intensive algorithm;
train an additional lightweight machine learning model based on the at least one additional training example to produce answers to questions of the different question type; and
use the additional lightweight machine learning model to produce an answer to a fourth question of the different question type.

14. The controller of claim 12, wherein the resource intensive algorithm answers the first question by tuning at least one or more input of a simulator until an output of the simulator sufficiently meets a criteria of the question.

15. The controller of claim 14, wherein the at least one training example includes:
output of the simulation as input, and
input to the simulation as output.

16. The controller of claim 12, wherein the resource intensive algorithm is a multi-agent optimizer.

17. The controller of claim 16, further comprising the processor configured to:
use the answer to the second question as a starting position of at least one agent of the multi-agent optimizer; and
use the multi-agent optimizer to produce a refined answer to the second question.

18. The controller of claim 16, wherein generating at least one training example comprises generating a training example from the location of an agent after each optimization iteration of the multi-agent optimizer.

19. A non-transitory machine-readable medium encoded with instructions for execution by a processor, the non-transitory machine-readable medium comprising:
instructions for using a resource intensive algorithm to answer a first question of a question type;
instructions for generating at least one training example from the normal operation of the resource intensive algorithm;
instructions for training a lightweight machine learning model based on the at least one training example to produce answers to questions of the question type; and
instructions for using the lightweight machine learning model to produce an answer to a second question of the question type.

20. The non-transitory machine-readable medium of claim 19 wherein the resource intensive algorithm utilizes a digital twin of a real world system to answer the first question.
